(19) United States
(12) Patent Application Publication
(10) Pub. No.: US 2026/0070214 A1
(43) Pub. Date: Mar. 12, 2026

(54) METHOD AND ELECTRONIC DEVICE FOR TRAINING POLICY MODEL BASED ON REINFORCEMENT LEARNING

(71) Applicant: Horizon Robotics Inc., Cupertino, CA (US)

(72) Inventors: Haichao ZHANG, Cupertino, CA (US); Yuwei FU, Cupertino, CA (US); Wei XU, Cupertino, CA (US)

(73) Assignee: Horizon Robotics Inc., Cupertino, CA (US)

(21) Appl. No.: 18/883,207

(22) Filed: Sep. 12, 2024

(51) Int. Cl. B25J 9/16

(52) U.S. Cl. CPC B25J 9/163; B25J 9/161

(57) ABSTRACT

The embodiment of the present discloses a method for training a policy model based on reinforcement learning and apparatus, and an electronic device. The method includes: determining an observation data sequence generated by an agent during a time period of executing a target task, a preset time window, and an expert data sequence corresponding to the target task; determining a cost matrix and a transport matrix based on the preset time window, the observation data sequence, and the expert data sequence; determining a reward value for each observation data in the observation data sequence based on the cost matrix and the transport matrix; and training the policy model based on the observation data and the reward value of the observation data.

### FIELD OF THE INVENTION

The present disclosure relates to the field of robot learning, and in particular, to a method, a computer readable storage medium and an electronic device for training a policy model based on reinforcement learning.

### BACKGROUND OF THE INVENTION

At present, reinforcement learning (RL) technologies have been widely applied in the field of robot learning. According to the reinforcement learning technologies, an agent may interact with an environment and continuously learn optimal strategies based on rewards fed back from the environment. In a reinforcement learning process, the agent may obtain a corresponding reward value after performing an action. Accuracy of the reward value may have direct impact on effects of the reinforcement learning.

### SUMMARY OF THE INVENTION

Usually, in reinforcement learning, an optimal transport reward value may be determined based on similarity between an agent execution trajectory and an expert demonstration trajectory. However, how to improve accuracy of the reward value is one of problems that urgently need to be resolved in policy model training.

To resolve the foregoing technical problem, the present disclosure provides a method, an apparatus, and an electronic device for training a policy model based on reinforcement learning, which can improve the accuracy of the reward value. In this way, reinforcement learning is performed based on the reward value with higher accuracy, so that a better policy model can be obtained.

According to a first aspect of the present disclosure, there is provided a method for training a policy model based on reinforcement learning, including: determining an observation data sequence generated by an agent during a time period of executing a target task, a preset time window corresponding to the target task, and an expert data sequence corresponding to the target task; determining a cost matrix and a transport matrix based on the preset time window, the observation data sequence, and the expert data sequence; determining a reward value for each observation data in the observation data sequence based on the cost matrix and the transport matrix; and training the policy model based on the observation data and the reward value of the observation data.

According to a second aspect of the present disclosure, there is provided a computer readable storage medium, on which a computer program is stored, wherein the computer program is configured to implement the method for training a policy model provided in the first aspect.

According to a third aspect of the present disclosure, there is provided an electronic device, including: a processor; and a memory configured to store processor-executable instructions, wherein the processor is configured to read the executable instructions from the memory, and execute the instructions to implement the method for training a policy model based on reinforcement learning provided in the first aspect.

According to a fourth aspect of the present disclosure, there is provided a computer program product, which, when instructions in the computer program product are executed by a processor, makes the processor implement the method for training a policy model based on reinforcement learning provided in the first aspect is implemented.

According to the method for training a policy model based on reinforcement learning provided in the present disclosure, through the preset time window, the observation data sequence may be divided into various observation data corresponding to the time window and the expert data sequence may be divided into various expert data corresponding to the time window. Therefore, when determining the cost matrix and the transport matrix, the observation data and expert data within the time window are considered only, and thus interference from other observation data or expert data outside the time window is excluded, thereby improving the accuracy of the reward value. In this case, when reinforcement learning is further performed based on the reward value with higher accuracy, a better policy model can be obtained.

### BRIEF DESCRIPTION OF THE DRAWINGS

FIG. 1 is a diagram of a scenario to which the present disclosure is applicable;

FIG. 2 is a schematic flowchart of applying an optimal transport reward in reinforcement learning according to the prior art;

FIG. 3 is a schematic diagram of a reward curve for optimal transport in a reinforcement learning process according to the prior art;

FIG. 4 is a schematic flowchart of a method for training a policy model based on reinforcement learning according to an exemplary embodiment of the present disclosure;

FIG. 5 is a schematic flowchart of an optimal transport reward considering timing information according to an exemplary embodiment of the present disclosure;

FIG. 6 is a schematic flowchart of a method for training a policy model based on reinforcement learning according to another exemplary embodiment of the present disclosure;

FIG. 7 is a schematic flowchart of a method for training a policy model based on reinforcement learning according to still another exemplary embodiment of the present disclosure;

FIG. 8 is a schematic flowchart of a method for training a policy model based on reinforcement learning according to yet another exemplary embodiment of the present disclosure;

FIG. 9 is a schematic flowchart of a method for training a policy model based on reinforcement learning according to still yet another exemplary embodiment of the present disclosure;

FIG. 10 is a schematic flowchart of a method for training a policy model based on reinforcement learning according to a further exemplary embodiment of the present disclosure;

FIG. 11 is a schematic flowchart of a method for training a policy model based on reinforcement learning according to a still further exemplary embodiment of the present disclosure;

FIG. 12 is a schematic diagram of a composition structure of an apparatus for training a policy model based on reinforcement learning according to an exemplary embodiment of the present disclosure;

FIG. 13 is a schematic diagram of a composition structure of an apparatus for training a policy model based on reinforcement learning according to another exemplary embodiment of the present disclosure; and

FIG. 14 is a schematic diagram of a composition structure of an electronic device according to an exemplary embodiment of the present disclosure.

### DETAILED DESCRIPTION OF THE EMBODIMENTS

To explain the present disclosure, exemplary embodiments of the present disclosure are described below in detail with reference to accompanying drawings. Obviously, the described embodiments are merely a part, rather than all of embodiments of the present disclosure. It should be understood that the present disclosure is not limited by the exemplary embodiments.

It should be noted that the scope of the present disclosure is not limited by relative arrangement, numeric expressions, and numerical values of components and steps described in these embodiments, unless otherwise specified.

### Application Overview

First, application scenarios of the present disclosure are introduced. A method for a reinforcement learning model provided in embodiments of the present disclosure may be applied to, for example, an autonomous driving scenario and a robot automation control scenario in the industrial field, and any other feasible scenarios.

For example, an agent may interact with an environment and continuously learn based on a reward value fed back from the environment to obtain an optimal policy for executing a task. In some examples, the agent may include a vehicle (such as a vehicle with an autonomous driving function), a robot, a robotic arm, and other devices or apparatuses that can intelligently interact with the environment. A type of the agent is not limited in the embodiments of the present disclosure.

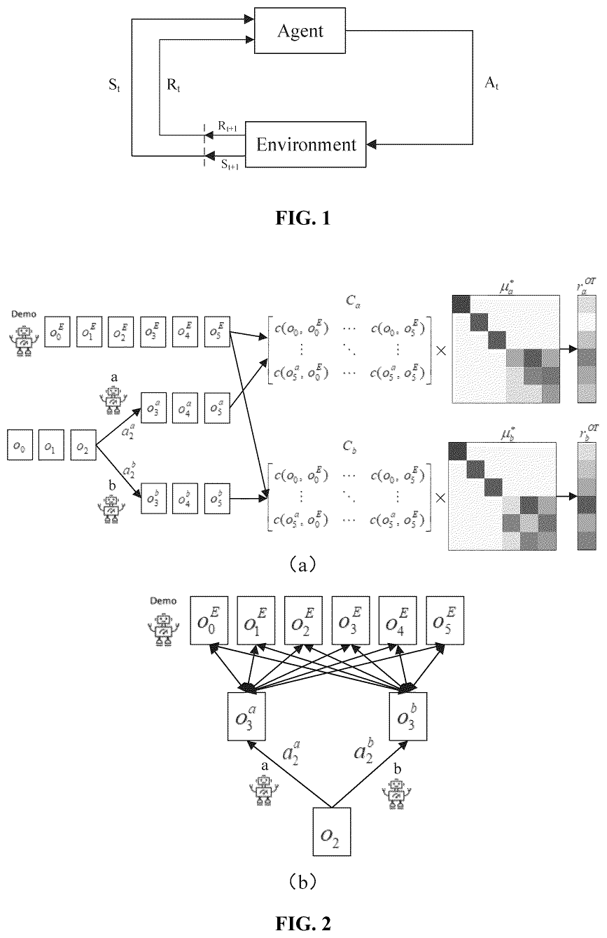

As shown in FIG. 1, when executing a target task, the agent first determines an execution action Aₜ and executes the same based on the current state Sₜ (representing the observations of the environment) and the policy model (parametrized by learnable parameters). By interacting with the environment through the action Aₜ, the agent may obtain from the environment a new state Sₜ₊₁, meanwhile the environment may provide a reward Rₜ. Subsequently, the agent adjusts the parameters of the policy model based on the state Sₜ₊₁ and the reward Rₜ (or batches of states and rewards), and determines a next execution action Aₜ₊₁ and executes the same based on the adjusted policy parameter. By interacting with the environment through the action Aₜ₊₁, the agent may obtain new state from environment Sₜ₊₂, meanwhile the environment may provide a new reward Rₜ₊₁. Further, the agent adjusts the policy parameter again based on the new state Sₜ₊₂ and the new reward Rₜ₊₁ (or a collection of states and reward values collected in a batch). This is repeated iteratively, until the agent learns an optimal policy parameter θ for executing the target task. For example, the optimal policy parameter θ may be a corresponding policy parameter when a cumulative reward value for executing the target task reaches a preset condition.

In a process in which the agent interacts with the environment, information such as where the agent is located within the environment and the objects around the robot need to be provided as observation to the agent, so as to adjust a policy parameter for the agent to execute the target task. Therefore, the foregoing information may be collected by setting a plurality of sensors. The sensors may be set on the agent, or outside the agent but connected to the agent in communication, so that the agent can obtain the environmental information via the sensors. In some examples, the foregoing sensors include but are not limited to an image sensor, a millimeter wave radar, a laser radar, an ultrasonic radar, a gyroscope sensor, a distance sensor, a light sensor, and a gravity sensor. The foregoing environmental parameters include but are not limited to images, millimeter wave signals, laser beam signals, ultrasonic signals, and ambient light intensity. The foregoing state parameters include but are not limited to a position and a posture of the agent.

Usually, in a reinforcement learning process, the agent may give a corresponding reward value based on the current state parameters after executing an action. Accuracy of the reward value may have direct impact on effects of the reinforcement learning. In related technologies, the reward value may be determined through optimal transport (OT), and then reinforcement learning is performed based on the reward value determined through the optimal transport.

Specifically, the reward value is determined through the optimal transport by comparing similarity between an agent execution trajectory and an expert demonstration trajectory. The agent execution trajectory includes multiple states observed by the agent when performing the target task, and the expert demonstration trajectory includes multiple states demonstrated by an expert when performing the same target task. In a reinforcement learning scenario based on the optimal transport, a Wasserstein distance is usually used to determine the similarity between the agent execution trajectory and the expert demonstration trajectory. Taking that the expert demonstration trajectory is

$${𝒯}^{E} = \{ {o}_{1}^{E} , … , {o}_{j}^{E} , … , {o}_{T}^{E} \}$$

and the agent execution trajectory is [symbol] ={o₁, . . . , oᵢ, . . . o_{T}} as an example, where oᵢ represents an i^{th} observation state and

$${o}_{j}^{E}$$

represents a j^{th} demonstration state, when determining the optimal transport reward, a value

$$c ( {o}_{i} , {o}_{j}^{E} )$$

of each element in a cost matrix C may be determined first based on each observation state oᵢ in the agent execution trajectory and each demonstration state

$${o}_{j}^{E}$$

in the expert demonstration trajectory; and then a value μ*(i,j) of each element in an optimal transport plan μ* may be determined based on the cost matrix C and finally, the optimal transport reward

$${r}_{i}^{O T}$$

may be calculated based on the cost matrix C and the optimal transport plan μ*.

The optimal transport reward, that is, a reward value determined based on the optimal transport, is used in the reinforcement learning to evaluate an effect of the agent after performing an action. If an observation state of the agent after performing the action is more similar to a corresponding demonstration state, a greater reward value may be given. For example, a value range of the reward value may be [−1, 0]. If the reward value given is closer to 0, it indicates a better effect of the agent after performing the action. A better policy model may be learned when the reinforcement learning is performed based on a reward value with higher accuracy.

For example, FIG. 2 exemplarily shows a schematic diagram of applying an optimal transport reward in reinforcement learning. As shown in FIG. 2 (a), that the expert demonstration trajectory and the agent execution trajectory both include 6 states, the expert demonstration trajectory satisfies

$${𝒯}^{E} = \{ {o}_{0}^{E} , {o}_{1}^{E} , {o}_{2}^{E} , {o}_{3}^{E} , {o}_{4}^{E} , {o}_{5}^{E} \} ,$$

an execution trajectory of an agent a satisfies

$${𝒯}^{a} = \{ {o}_{0} , {o}_{1} , {o}_{2} , {o}_{3}^{a} , {o}_{4}^{a} , {o}_{5}^{a} \} ,$$

and an execution trajectory of an agent b satisfies

$${𝒯}^{b} = \{ {o}_{0} , {o}_{1} , {o}_{2} , {o}_{3}^{b} , {o}_{4}^{b} , {o}_{5}^{b} \}$$

is used as an example. The two agents are the same in first two states, and respectively perform different actions

$${a}_{2}^{a} and {a}_{2}^{b}$$

after a second state. As shown in FIG. 2 (b), the agent a may perform the action

$${a}_{2}^{a}$$

and the agent b may perform the action

$${a}_{2}^{b} .$$

The agents a and b respectively perform different actions in a same state. Quality of the two actions

$${a}_{2}^{a} and {a}_{2}^{b}$$

may be measured based on an amplitude of an optimal transport reward value

$${r}_{3}^{O T} ( [ {o}_{3}^{a} , {o}_{4}^{a} , {o}_{5}^{a} ] , [ {o}_{3}^{E} , {o}_{4}^{E} , {o}_{5}^{E} ] )$$

calculated based on the agent trajectory starting from observation

$${o}_{3}^{a}$$

and an amplitude of an optimal transport reward value

$${r}_{3}^{O T} ( [ {o}_{3}^{b} , {o}_{4}^{b} , {o}_{5}^{b} ] , [ {o}_{3}^{E} , {o}_{4}^{E} , {o}_{5}^{E} ] )$$

the agent trajectory starting from observation

$${o}_{3}^{b} .$$

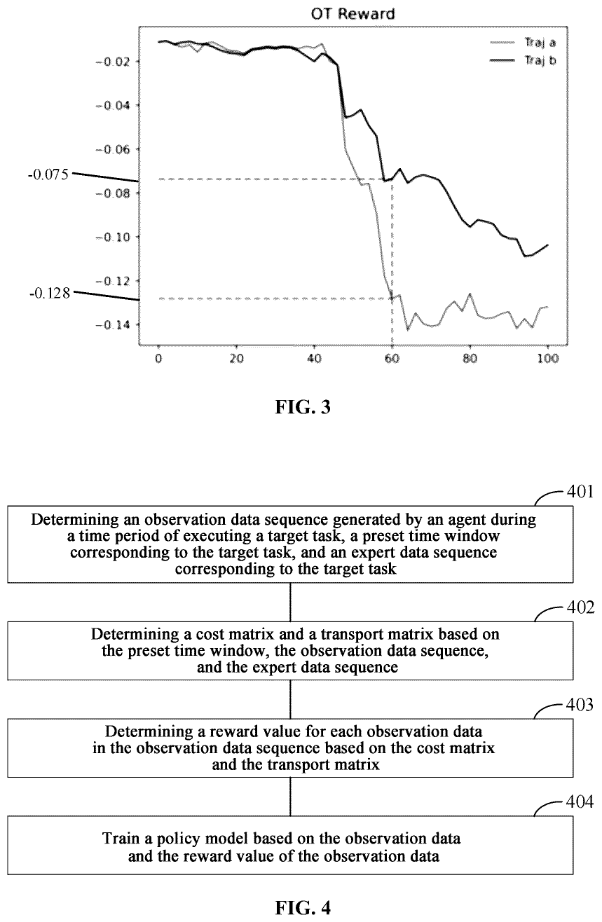

Specifically, FIG. 3 exemplarily shows optimal transport reward curves corresponding to states of the agents a and b at different moments when respectively performing the target task. A horizontal coordinate in FIG. 3 represents a time step, and a vertical coordinate represents the optimal transport reward. As shown in FIG. 3, a time step corresponding to a third observation state is 60, an optimal transport reward of the third observation state

$${o}_{3}^{a}$$

of the agent a is −0.128, and an optimal transport reward of the third observation state

$${o}_{3}^{b}$$

of the agent b is −0.075. The the optimal transport reward (−0.075) of the third observation state

$${o}_{3}^{b}$$

of the agent b is greater than the optimal transport reward (−0.128) of the third observation state

$${o}_{3}^{a}$$

of the agent a, and it is determined that the action

$${a}_{2}^{b}$$

performed by the agent b is better than the action

$${a}_{2}^{a}$$

performed by the agent a.

However, when the optimal transport reward is determined according to the foregoing scheme, the temporal ordering of various states in the agent execution trajectory and the temporal ordering of various states in the expert demonstration trajectory are not considered. For example, that the expert demonstration trajectory satisfies [symbol] ==(s₁, s₁, s₂), which means starting from a state s₁, first staying at the state s₁, and then moving to a state s₂; and an imitation trajectory satisfies [symbol] =(s₁, s₂, s₁), which means starting from the state s₁, first moving to the state s₂, and then moving back to the state s₁, is used as an example. Obviously, the imitation trajectory [symbol] does not match the expert demonstration trajectory [symbol] . However, when the optimal transport reward for each state in the imitation trajectory [symbol] is determined according to the foregoing scheme, since a sequential order of states in the trajectory is not considered, consistency between the imitation trajectory [symbol] and the expert demonstration trajectory [symbol] cannot be distinguished, resulting in low accuracy of the reward value of the determined imitation trajectory [symbol] . Therefore, when performing the reinforcement learning by using a reward value with a low accuracy, the agent may fail to learn a better policy model.

To resolve the technical problem in the related art that the agent cannot learn a better policy model due to the low accuracy of the reward value determined based on the optimal transport, the embodiments of the present disclosure provide a method for training a policy model based on reinforcement learning. According to this method, based on optimal transport, in combination with a preset time window, an observation data sequence of the agent is divided into various observation data corresponding to the time window, and an expert data sequence is divided into various expert data corresponding to the time window. When determining the cost matrix and the transport matrix, the observation data and expert data within the time window are considered only, and thus interference from other observation data or expert data outside the time window is excluded, thereby improving the accuracy of the reward value. In this case, when the reinforcement learning is performed based on the reward value with higher accuracy, it can be ensured that a better policy model is learned.

### Exemplary Method

FIG. 4 is a schematic flowchart of a method for training a policy model based on reinforcement learning according to an exemplary embodiment of the present disclosure. This embodiment of the present disclosure may be applied to an electronic device. As shown in FIG. 4, the method includes the following steps 401 to 404.

Step 401: determining an observation data sequence generated by an agent during a time period of executing a target task, a preset time window corresponding to the target task, and an expert data sequence corresponding to the target task.

For example, when the type of the agent varies, target tasks executed by the agent may also be different. Taking the agent as a robotic arm as an example, the target tasks executed by the agent include but are not limited to shooting, button pressing, door opening, drawer closing, lever pulling, object placement, and sweeping, and the like. The type of the agent is not limited in this embodiment of the present disclosure, and exemplary description is made in the following embodiments by using an example in which the agent is a robotic arm.

For example, the target task may be executed through a series of actions performed by the agent during interaction with a surrounding environment. The observation data sequence and the expert data sequence are data sequences generated when the agent and the expert perform the same target task, respectively. An electronic device obtains a plurality of observation data generated during the time period when the agent executes the target task, and sorts the observation data in an order of generation time to form an observation data sequence. The expert data sequence corresponding to the observation data sequence includes a plurality of expert data generated by the expert when executing the same target task, and the plurality of expert data are sorted in an order of generation time to form the expert data sequence.

For example, the observation data may be observation image data detected by an image sensor, an observation ultrasonic signal detected by an ultrasonic sensor, or state observation data detected by other sensors that can characterize a state. This is not limited in this embodiment of the present disclosure. Corresponding to the observation data, the expert data may be expert image data detected by the image sensor, an expert ultrasonic signal detected by the ultrasonic sensor, or state expert data detected by other sensors that can characterize a state. For example, the observation data is own trajectory information or own posture information of the agent, and the expert data is expert trajectory information or expert posture information.

In some embodiments, the observation data sequence may include a plurality of observation data arranged in the temporal ordering, and the expert data sequence may include a plurality of expert data arranged in the temporal ordering. Taking that both the observation data and the expert data are image data as an example, the number of frames of observation image data included in the observation data sequence and the number of frames of expert image data included in the expert data sequence may be same or different, and this is not limited in the present disclosure. Exemplary description is made in the following embodiments by using an example in which the number of the observation data included in the observation data sequence and the number of the expert data included in the expert data sequence are the same.

For example, the preset time window corresponding to the target task may be a preset parameter. The preset time window is an integer greater than 1. By introducing the preset time window, when calculating the optimal transport reward, the observation data in the observation data sequence that is within the time window and the expert data in the expert data sequence that is within the time window may be considered to determine the reward value. In this case, the interference of the other data outside the time window can be excluded, thereby ensuring that accuracy of the determined reward value is higher.

Step 402: determining a cost matrix and a transport matrix based on the preset time window, the observation data sequence, and the expert data sequence.

For example, a value of each element in the cost matrix represents a cost value of each observation data in the observation data sequence and each expert data in the expert data sequence, that is, the cost or price required for the agent to transfer from a state corresponding to each observation data to a state corresponding to each expert data. The transport matrix is also referred to as a transport plan or an optimal transport plan. A value of each element in the transport matrix represents a transfer amount of each observation data in the observation data sequence and each expert data in the expert data sequence.

In some examples, when determining the cost matrix and the transport matrix, the time window may be introduced merely in calculation of the cost matrix, so as to determine the cost matrix in combination with the observation data and the expert data that are within the time window. The cost matrix determined in this way considers timing performance of a plurality of observation data in the observation data sequence and timing performance of a plurality of expert data in the expert data sequence, which can exclude interference of other data outside the time window. Therefore, it can be ensured that the determined cost matrix is better, and thus accuracy of the reward value determined based on the cost matrix is higher.

In some examples, when determining the cost matrix and the transport matrix, the time window may be introduced merely in calculation of the transport matrix, so as to determine the transport matrix in combination with a time mask matrix. The transport matrix determined in this way limits a use scope of the optimal transport reward, which can exclude interference of other data outside the time window. Therefore, it can be ensured that the determined transport matrix is better, and accuracy of the reward value determined based on the transport matrix is higher.

In some examples, when determining the cost matrix and the transport matrix, the time window may be introduced in both the calculation of the cost matrix and the calculation of the transport matrix. In this case, the preset time window may include a first time window and a second time window. The first time window and the second time window may be same or different, which is not limited in the embodiments of the present disclosure. When the first time window is different from the second time window, the first time window may be larger than the second time window.

For example, referring to FIG. 5 (a), that the number of the observation data included in the observation data sequence and the number of the expert data included in the expert data sequence are the same is used as an example. The observation data sequence includes T observation data, denoted as {o₀, o₁, . . . , oᵢ, . . . , o_{T-1}}; the expert data sequence includes T expert data, denoted as

$$\{ {o}_{0}^{E} , {o}_{1}^{E} , … , {o}_{j}^{E} , … , {o}_{T - 1}^{E} \} ;$$

and the preset time window is denoted as k. The cost matrix (which is denoted as Ĉ) and the transport matrix (which is denoted as μ*) considering the timing information may be determined based on the preset time window k, the T observation data {o₀, o₁, . . . , oᵢ, . . . , o_{T-1}}, and the T expert data

$$\{ {o}_{0}^{E} , {o}_{1}^{E} , … , {o}_{j}^{E} , … , {o}_{T - 1}^{E} \} .$$

Sizes of the cost matrix Ĉ and the transport matrix μ* are related to the number of the observation data in the observation data sequence and the number of the expert data in the expert data sequence. As shown in FIG. 5 (a), when the observation data sequence includes T observation data and the expert data sequence includes T p expert data, the cost matrix Ĉ and the transport matrix μ* determined are both T×T matrices. The value of each element in the cost matrix Ĉ and the transport matrix μ* may be determined based on the observation data in the preset time window and the expert data in the corresponding time window.

The cost matrix determined in this way considers the timing performance of a plurality of observation data in the observation data sequence and the timing performance of a plurality of expert data in the expert data sequence. The determined transport matrix limits the use scope of the optimal transport reward, which can exclude the interference of other data outside the time window. Therefore, it can be ensured that the cost matrix and the transport matrix determined are better, and thus, accuracy of the reward value determined based on the cost matrix and the transport matrix is higher.

Step 403: determining a reward value for each observation data in the observation data sequence based on the cost matrix and the transport matrix.

For example, after determining the cost matrix Ĉ and the transport matrix μ* that consider the timing information, a reward value

$${r}_{i}^{O T}$$

of an i^{th} observation data oᵢ in the observation data sequence may be calculated based on the optimal transport. The reward value

$${r}_{i}^{O T}$$

may also be referred to as an optimal transport reward. The reward value

$${r}_{i}^{O T}$$

may be determined according to the following formula (1):

$${r}_{i}^{O T} = - {\sum }_{j = 0}^{T - 1} \hat{c} ( {o}_{i} , {o}_{j}^{E} ) {μ}^{*} ( i , j ) . \qquad ( 1 )$$

In formula (1),

$$\hat{c} ( {o}_{i} , {o}_{j}^{E} )$$

represents a value of an element in an i^{th} row and a j^{th} column of the cost matrix Ĉ, and μ*(i,j) represents a value of an element in an i^{th} row and a j^{th} column of the transport matrix μ*.

In this embodiment of the present disclosure, the cost matrix and the transport matrix are determined in combination with the preset time window based on each observation data corresponding to the time window in the observation data sequence and each expert data corresponding to the time window in the expert data sequence, with the timing performance of a plurality of observation data in the observation data sequence and the timing performance of a plurality of expert data in the expert data sequence considered. The determined reward value can exclude the interference from other data outside the time window, thereby improving the accuracy of the reward value.

Step 404: training the policy model based on the observation data and the reward value of the observation data.

For example, when the agent performs reinforcement learning based on the observation data and the reward value of the observation data, since the reward value of the observation data is determined by considering context data of the observation data within the time window, this reward value is more accurate than a reward value determined without considering the context data. Therefore, when the policy model is trained based on the reward value with higher accuracy, better policy parameters can be learned.

The policy model is used to determine a new action execution model according to different states generated by the agent during the execution of the target task.

According to the method for training a policy model based on reinforcement learning provided in this embodiment of the present disclosure, the cost matrix and the transport matrix may be determined in combination with the preset time window based on each observation data corresponding to the time window in the observation data sequence and each expert data corresponding to the time window in the expert data sequence only. In this case, the interference from the other data outside the time window can be excluded, thereby improving the accuracy of the reward value. Therefore, when the reinforcement learning is performed based on the reward value with higher accuracy, it can be ensured that a better policy model is learned.

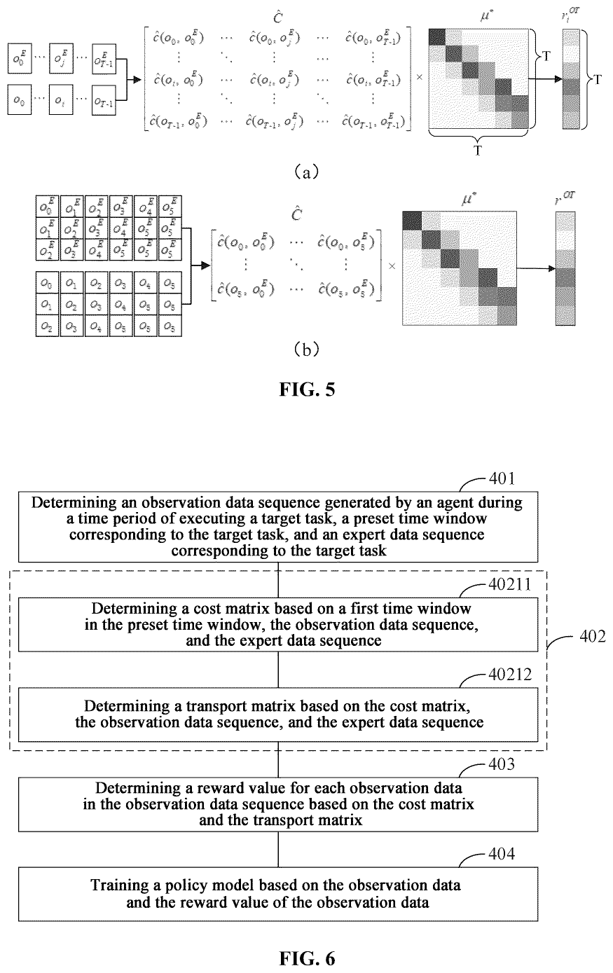

In an implementation, as shown in FIG. 6, on the basis of the embodiment shown in FIG. 4, step 402 may include the following steps 40211 and 40212.

Step 40211: determining the cost matrix based on a first time window in the preset time window, the observation data sequence, and the expert data sequence.

For example, the preset time window may include the first time window, which is denoted as k_{c}. A plurality of observation data in the first time window may be used as context data of each observation data, and the value of each element

$$\hat{c} ( {o}_{i} , {o}_{j}^{E} )$$

in the cost matrix Ĉ may be determined in combination with the context data of each observation data by using a calculation formula as the following formula (2):

$$\hat{c} ( {o}_{i} , {o}_{j}^{E} ) = \frac{1}{{k}_{c}} {\sum }_{h = 0}^{{k}_{c} - 1} ( 1 - \frac{〈 f ( {o}_{i + h} ) , f ( {o}_{j + h}^{E} ) 〉}{‖ f ( {o}_{i + h} ) ‖ ‖ f ( {o}_{j + h}^{E} ) ‖} ) . \qquad ( 2 )$$

In formula (2), f(oᵢ₊ₕ) represents a context feature in the first time window corresponding to the i^{th} observation data oᵢ extracted based on the encoder. If the first time window k_{c} is 1, the context data is not considered when calculating the value of each element

$$\hat{c} ( {o}_{i} , {o}_{j}^{E} ) .$$

To ensure that the calculated reward value is more accurate, the context data may be considered when determining the cost matrix. Therefore, in the embodiments of the present disclosure, the first time window k_{c} may be an integer greater than 1. Moreover, a value of the first time window k_{c} would not exceed the number T of the observation data in the observation data sequence. Therefore, a value range of k_{c} is greater than 1 and less than or equal to T.

In the embodiments of the present disclosure, when determining the cost matrix in combination with the first time window, by considering the timing performance of the observation data in the observation data sequence and the timing performance of the expert data in the expert data sequence, the cost value of each observation data may be determined based on cost values of multiple observation data within the time window and multiple expert data within the time window. In this case, the interference of other data outside the time window that is not temporally relevant can be excluded, thereby improving the accuracy of the reward value.

Step 40212: determining the transport matrix based on the cost matrix, the observation data sequence and the expert data sequence.

For example, the transport matrix μ* is an optimal transport matrix obtained by optimizing a basic transport matrix μ, and may be determined based on the cost matrix Ĉ, the observation data sequence {o₀, o₁, . . . , oᵢ, . . . , o_{T-1}}, and the expert data sequence

$$\{ {o}_{0}^{E} , {o}_{1}^{E} , … , {o}_{j}^{E} , … , {o}_{T - 1}^{E} \} .$$

For example, the optimal transport value μ*(i,j) of each element μ(i,j) in the basic transport matrix μ may be calculated according to an iterative algorithm (such as the Sinkhorn algorithm), to obtain the transport matrix μ*. In practical applications, another iterative optimization algorithm may also be used to calculate the optimal transport value μ*(i,j) of each element u (i,j) in the basic transport matrix μ, to obtain the transport matrix μ*. The iterative optimization algorithm adopted is not limited in the embodiments of the present disclosure.

In the embodiments of the present disclosure, when determining the cost matrix in combination with the first time window, by considering the timing performance of the observation data in the observation data sequence and the timing performance of the expert data in the expert data sequence, the interference of other data outside the time window that is not temporally relevant can be excluded, thereby ensuring that accuracy of the determined cost matrix related to the timing information is higher. Determining the transport matrix based on the cost matrix with higher accuracy can improve the accuracy of the transport matrix. Thus, a reward value with higher accuracy can be determined based on the cost matrix and the transport matrix with higher accuracy.

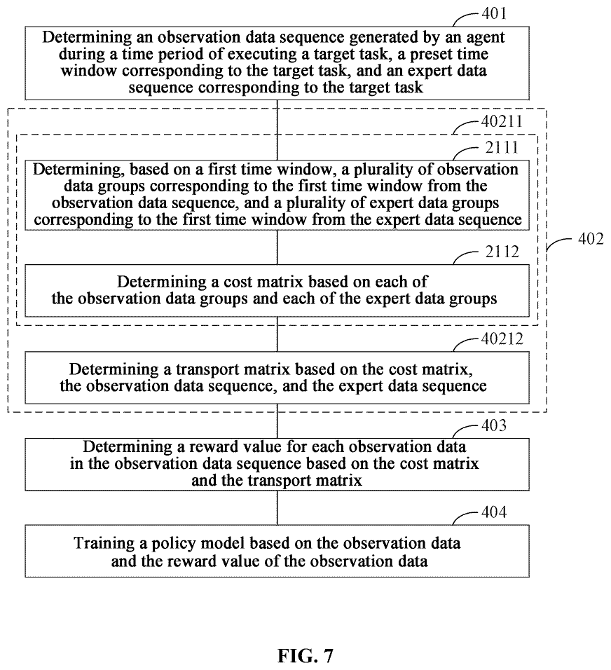

In some embodiments, as shown in FIG. 7, step 40211 may specifically include the following steps 2111 and 2112.

Step 2111: determining, based on the first time window, a plurality of observation data groups corresponding to the first time window from the observation data sequence, and a plurality of expert data groups corresponding to the first time window from the expert data sequence.

Context data of each observation data is determined in the observation data sequence based on the first time window, to obtain the plurality of observation data groups corresponding to the first time window. Context data of each expert data is determined in the expert data sequence based on the first time window, to obtain the plurality of expert data groups corresponding to the first time window. The number of observation data included in each observation data group is same as that of expert data included in each expert data group, both being equal to a size of the first time window.

When determining a plurality of observation data groups corresponding to the first time window k_{c}, the plurality of observation data groups may be obtained by sliding in the observation data sequence based on the first time window k_{c}. An observation data group includes context data of an observation data, and the number of observation data included in each observation data group is k_{c}. For example, as shown in FIG. 5 (b), taking that a value of T is 6, the observation data sequence is {o₀, o₁, o₂, o₃, o₄, o₅}, and the value of the first time window k_{c} is 3 as an example, the plurality of determined observation data groups respectively are: an observation data group (o₀, o₁, o₂) corresponding to o₀; an observation data group (o₁, o₂, o₃) corresponding to o₁; an observation data group (o₂, o₃, o₄) corresponding to o₂; an observation data group (o₃, o₄, o₅) corresponding to o₃; an observation data group (o₄, o₅, o₅) corresponding to o₄; and an observation data group (o₅, o₅, o₅) corresponding to o₅. It should be noted that, to ensure that each observation data group includes 3 observation data, the observation data in last two observation data groups may be padded with a last observation data.

Similarly, when determining a plurality of expert data groups corresponding to the first time window k_{c}, the plurality of expert data groups may be obtained by sliding in the expert data sequence based on the first time window. An expert data group includes context data of an expert data, and the number of the expert data included in each expert data group is k_{c}. For example, as shown in FIG. 5 (b), taking that the value of T is 6, the expert data sequence is

$$\{ {o}_{0}^{E} , {o}_{1}^{E} , {o}_{2}^{E} , {o}_{3}^{E} , {o}_{4}^{E} , {o}_{5}^{E} \} ,$$

and the value of the first time window k_{c} is 3 as an example, the plurality of determined expert data groups respectively are: an expert data group

$$( {o}_{0}^{E} , {o}_{1}^{E} , {o}_{2}^{E} )$$

corresponding to

$${o}_{0}^{E} ;$$

an expert data group

$$( {o}_{1}^{E} , {o}_{2}^{E} , {o}_{3}^{E} )$$

corresponding to

$${o}_{1}^{E} ;$$

an expert data group

$$( {o}_{2}^{E} , {o}_{3}^{E} , {o}_{4}^{E} )$$

corresponding to

$${o}_{2}^{E} ;$$

an expert data group

$$( {o}_{3}^{E} , {o}_{4}^{E} , {o}_{5}^{E} )$$

corresponding to

$${o}_{3}^{E} ;$$

an expert data group

$$( {o}_{4}^{E} , {o}_{5}^{E} , {o}_{5}^{E} )$$

corresponding to

$${o}_{4}^{E}$$

and an expert data group

$$( {o}_{5}^{E} , {o}_{5}^{E} , {o}_{5}^{E} )$$

corresponding to

$${o}_{5}^{E} .$$

It should be noted that, to ensure that each expert data group includes 3 expert data, the expert data in last two expert data groups may be padded with a last expert data.

Step 2112: determining the cost matrix based on each of the observation data groups and each of the expert data groups.

For example, the cost value of each observation data in each observation data group and each expert data in each expert data group may be determined based on cosine similarity, so as to obtain the value of each element in the cost matrix C, thereby obtaining the cost matrix.

In an implementation, step 2112 may include the following steps 21121 to 21123.

Step 21121: determining a first cost value for each observation data in each of the observation data groups and corresponding expert data in each of the expert data groups based on a plurality of observation data in each of the observation data groups and a plurality of expert data in each of the expert data groups.

For example, the first cost value for each observation data in each observation data group and the corresponding expert data in each expert data group is calculated based on the observation data group corresponding to each observation data in o₀ to o₅ and the expert data group corresponding to each expert data in

$${o}_{0}^{E} to {o}_{5}^{E} .$$

The first cost value for each observation data and each expert data represents the cost required for the agent to transfer from the state corresponding to each observation data to the state corresponding to each expert data.

For example, the first cost value for oᵢ and

$${o}_{j}^{E}$$

may be calculated according to the cosine similarity-based cost function shown in the following formula (3):

$$c ( {o}_{i} , {o}_{j}^{E} ) = 1 - \frac{〈 f ( {o}_{i} ) , f ( {o}_{j}^{E} ) 〉}{‖ f ( {o}_{i} ) ‖ ‖ f ( {o}_{j}^{E} ) ‖} . \qquad ( 3 )$$

In formula (3), f(oᵢ) represents a feature of the observation data oᵢ extracted by the encoder, and

$$\hat{c} ( {o}_{i} , {o}_{j}^{E} )$$

represents the costs or price required to transfer from a state corresponding to i^{th} observation data oᵢ to a state corresponding to j^{th} expert data, that is, the first cost value for oᵢ and

$${o}_{j}^{E} .$$

As shown in FIG. 5 (b), taking the observation data group (o₀, o₁, o₂) corresponding to o₀ and the expert data group

$$( {o}_{0}^{E} , {o}_{1}^{E} , {o}_{2}^{E} )$$

corresponding to

$${o}_{0}^{E}$$

as an example, a first cost value

$$c ( {o}_{0} , {o}_{0}^{E} )$$

for the observation data o₀ and the expert data

$${o}_{0}^{E} ,$$

a first cost value

$$c ( {o}_{1} , {o}_{1}^{E} )$$

for the observation data o₁ and the expert data

$${o}_{1}^{E} ,$$

and a first cost value

$$c ( {o}_{2} , {o}_{2}^{E} )$$

for the observation data o₂ and the expert data

$${o}_{2}^{E}$$

may be calculated according to the cost function shown in formula (3). Further, taking the observation data group (o₀, o₁, o₂) corresponding to o₀ and the expert data group

$$( {o}_{5}^{E} , {o}_{5}^{E} , {o}_{5}^{E} )$$

corresponding to

$${o}_{5}^{E}$$

as an example, a first cost value

$$c ( {o}_{0} , {o}_{5}^{E} )$$

for the observation data o₀ and the expert data

$${o}_{5}^{E} ,$$

a first cost value

$$c ( {o}_{1} , {o}_{5}^{E} )$$

for the observation data o₁ and the expert data

$${o}_{5}^{E} ,$$

and a first cost value

$$c ( {o}_{2} , {o}_{5}^{E} )$$

for the observation data o₂ and the expert data

$${o}_{5}^{E}$$

are calculated according to the cost function formula shown in formula (3). Similarly, the first cost value for each observation data in each observation data group and the corresponding expert data in each expert data group is calculated.

Step 21122: determining a second cost value for each observation data and each expert data based on the first cost value for each observation data in each of the observation data groups and the corresponding expert data in each of the expert data groups.

The second cost value for each observation data and each expert data represents the cost required for the agent to transfer from the state corresponding to each observation data to the state corresponding to each expert data considering the timing information. For example, a second cost value

$$\hat{c} ( {o}_{i} , {o}_{j}^{E} )$$

for o₀ and

$${o}_{0}^{E}$$

may be calculated based on first cost values of a plurality of observation data o₀ within the time window. Specifically, the second cost value may be calculated based on the first cost value

$$c ( {o}_{0} , {o}_{0}^{E} )$$

for the observation data o₀ and the expert data

$${o}_{0}^{E} ,$$

the first cost value

$$c ( {o}_{1} , {o}_{1}^{E} )$$

for the observation data o₁ and the expert data

$${o}_{1}^{E} ,$$

and the first cost value

$$c ( {o}_{2} , {o}_{2}^{E} )$$

for the observation data o₂ and the expert data

$${o}_{2}^{E}$$

by using a calculation formula as the following formula (4):

$$\hat{c} ( {o}_{0} , {o}_{0}^{E} ) = \frac{1}{3} ( c ( {o}_{0} , {o}_{0}^{E} ) + c ( {o}_{1} , {o}_{1}^{E} ) + c ( {o}_{2} , {o}_{2}^{E} ) ) . \qquad ( 4 )$$

Similarly, the second cost value

$$\hat{c} ( {o}_{i} , {o}_{j}^{E} )$$

for the observation data oᵢ and each expert

$${o}_{j}^{E}$$

is calculated based on the first cost value for each observation data oᵢ and each expert data

$${o}_{j}^{E} .$$

Step 21123: determining the cost matrix based on the second cost value for each observation data and each expert data.

For example, the second cost value

$$\hat{c} ( {o}_{i} , {o}_{j}^{E} )$$

for each observation data oᵢ and each expert data

$${o}_{j}^{E}$$

is used as the value of each element in the cost matrix Ĉ considering the timing information, so as to obtain the cost matrix.

In the embodiments of the present disclosure, when determining the cost matrix in combination with the first time window, the timing performance of the observation data in the observation data sequence and the timing performance of the expert data in the expert data sequence are considered. The second-cost value for the observation data and the expert data is determined based on the first cost value for a plurality of observation data of this observation data in the time window and a plurality of expert data of this expert data in the time window, which can exclude the interference of the other data outside the time window, thereby improving the accuracy of the cost matrix. Further, a transport matrix with higher accuracy is determined based on the cost matrix with higher accuracy, and the accuracy of the reward value determined based on the cost matrix and the transport matrix with higher accuracy is higher.

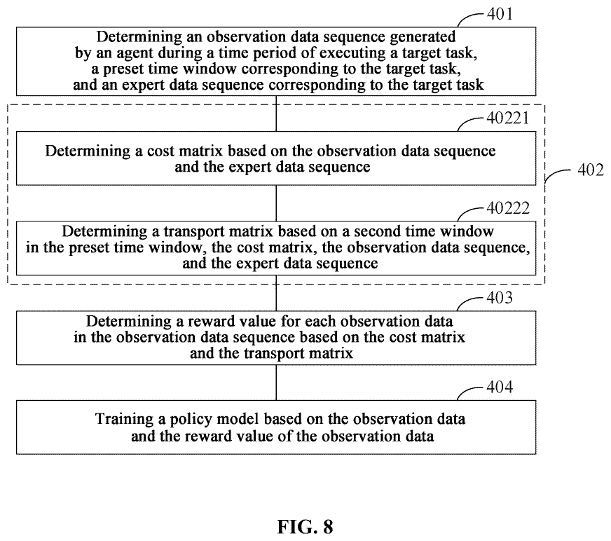

In another implementation, as shown in FIG. 8, on the basis of the embodiment shown in FIG. 4, step 402 may include the following steps 40221 and 40222.

Step 40221: determining the cost matrix based on the observation data sequence and the expert data sequence.

For example, the observation data sequence may be {o₀, o₁, . . . , oᵢ, . . . , o_{T-1}} and the expert data sequence may be

$$\{ {o}_{0}^{E} , {o}_{1}^{E} , … , {o}_{j}^{E} , … , {o}_{T - 1}^{E} \} .$$

The first cost value

$$c ( {o}_{i} , {o}_{j}^{E} )$$

for the observation data oᵢ and the expert data

$${o}_{j}^{E}$$

may be calculated according to the cost function shown in formula (3), and the first cost value

$$c ( {o}_{i} , {o}_{j}^{E} )$$

for each observation data oᵢ and each expert data

$${o}_{j}^{E}$$

is used as a value or each element in a cost matrix C, so as to obtain the cost matrix C. The cost matrix C is a cost matrix determined according to an existing optimal transport method without considering the timing information.

Step 40222: determining the transport matrix based on a second time window in the preset time window, the cost matrix, the observation data sequence, and the expert data sequence.

For example, the preset time window may include the second time window, which is denoted as kₘ. When optimizing the basic transport matrix μ to obtain the optimal transport matrix, the timing information may be embedded to determine the transport matrix μ* related to the timing information. When considering the timing information, time masking may be performed on the basic transport matrix μ based on the second time window kₘ to obtain a time mask transport matrix, which is denoted as M⊙μ. Subsequently, the time mask transport matrix M⊙μ is optimized based on the cost matrix C, the observation data sequence {o₀, o₁, . . . , oᵢ, . . . , o_{T-1}}, and the expert data sequence

$$\{ {o}_{0}^{E} , {o}_{1}^{E} , … , {o}_{j}^{E} , … , {o}_{T - 1}^{E} \} ,$$

so as to obtain the transport matrix μ* related to the timing information. Specifically, the transport matrix μ* related to the timing information may be represented in a vector form according to the following formula (5):

$${μ}^{*} = {arg min}_{μ} {〈 M ⊙ μ , C 〉}_{F} - ϵℋ ( M ⊙ μ ) s . t . μ1 = {μ}^{T} 1 = s . \qquad ( 5 )$$

In formula (5), [symbol] ·,· [symbol] represents a Frobenius norm (which is also referred to as a F-norm). M⊙μ represents term-by-term multiplication of M and μ, where M represents the time mask matrix, and M(i,j)∈[0,1]. [symbol] (·) represents an entropy regularization term of the time mask transport matrix M⊙μ. A sum of rows and a sum of columns of the basic transport matrix μ meet a constraint condition

$$s = [ \frac{1}{T} , … , \frac{1}{T} ] .$$

For example, formula (5) may be transformed into an unconstrained optimization problem through the Lagrangian function for solution. An objective function of the unconstrained optimization problem is shown in formula (6):

$$L ( μ , α , β ) = {〈 M ⊙ μ , C 〉}_{F} + ϵ ( {〈 M ⊙ μ , log ( M ⊙ μ ) 〉}_{F} - {1}^{T} ( M ⊙ μ ) 1 ) - {〈 α , ( M ⊙ μ ) 1 - s 〉}_{F} - {〈 β , {( M ⊙ ρ )}^{T} 1 - s 〉}_{F} . \qquad ( 6 )$$

In formula (6), α and β represent two Lagrangian multipliers.

It should be noted that a value of the second time window kₘ is not limited in the embodiments of the present disclosure. A smaller value of the second time window kₘ indicates a smaller use scope of the optimal transport reward and a tighter temporal constraint on matching an agent execution trajectory with an expert demonstration trajectory.

In the embodiments of the present disclosure, time masking is performed through the second time window, so that a use scope of the optimal transport reward can be limited, thereby improving the quality of the transport matrix.

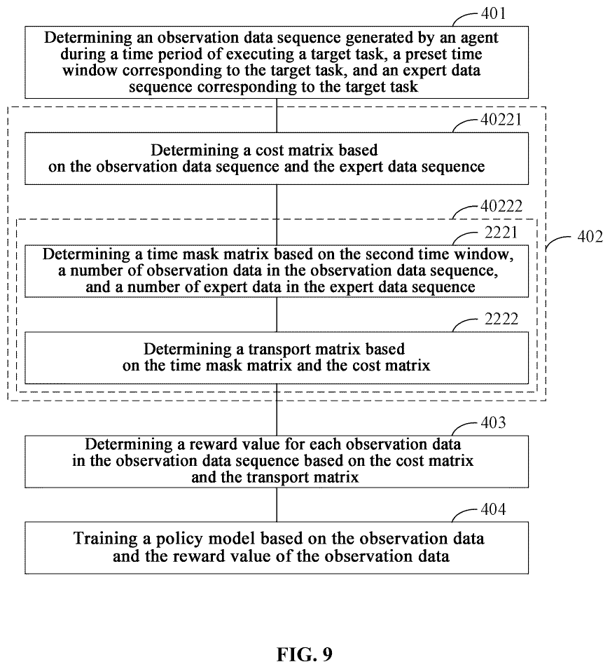

In some embodiments, as shown in FIG. 9, step 40222 may include the following steps 2221 and 2222.

Step 2221: determining a time mask matrix based on the second time window, a number of observation data in the observation data sequence, and a number of expert data in the expert data sequence.

In an implementation, first, a size of the time mask matrix is determined based on the number of the observation data in the observation data sequence and the number of the expert data in the expert data sequence; and then a value of each element in the time mask matrix is determined based on the size of the time mask matrix and the second time window.

For example, taking that the observation data sequence is {o₀, o₁, o₂, o₃, o₄, o₅} and the expert data sequence is

$$\{ {o}_{0}^{E} , {o}_{1}^{E} , {o}_{2}^{E} , {o}_{3}^{E} , {o}_{4}^{E} , {o}_{5}^{E} \}$$

as an example, the number of the observation data in the observation data sequence and the number of the expert data in the expert data sequence are both 6, and it may be determined that the size of the time mask matrix M is 6×6. The value of each element in the time mask matrix M may be determined according to the following formula (7):

$$M ( i , j ) = \{ \begin{matrix}1 , if j ∈ [ i - {k}_{m} , i + {k}_{m} ] \\ 0 , otherwise\end{matrix} . \qquad ( 7 )$$

wherein 0≤kₘ<T, and T represents the number of the expert data in the expert data sequence. When the value of kₘ is 0, M presents a unit matrix. When the value of kₘ is T−1, M presents a matrix with all elements being 1. For example, when the value of the first time window kₘ is 1, the time mask matrix M satisfies

$$M = [ \begin{matrix}1 & 1 & 0 & 0 & 0 & 0 \\ 1 & 1 & 1 & 0 & 0 & 0 \\ 0 & 1 & 1 & 1 & 0 & 0 \\ 0 & 0 & 1 & 1 & 1 & 0 \\ 0 & 0 & 0 & 1 & 1 & 1 \\ 0 & 0 & 0 & 0 & 1 & 1\end{matrix} ] .$$

In the embodiments of the present disclosure, kₘ time masking is performed through the second time window, so that the use scope of the optimal transport reward can be limited, thereby improving the quality of the transport matrix.

Step 2222: determining the transport matrix based on the time mask matrix and the cost matrix.

After being determined, the time mask matrix M and the cost matrix C may be substituted into the formula (6) to calculate the transport matrix μ* related to the timing information.

In the embodiments of the present disclosure, when the transport matrix is determined in combination with the second time window, time masking is performed on the transport matrix through the time mask matrix generated by the second time window, so that the use scope of the optimal transport reward can be limited, so as to obtain the transport matrix with higher accuracy. In this case, the accuracy of the reward value determined based on the cost matrix and the transport matrix with higher accuracy is higher.

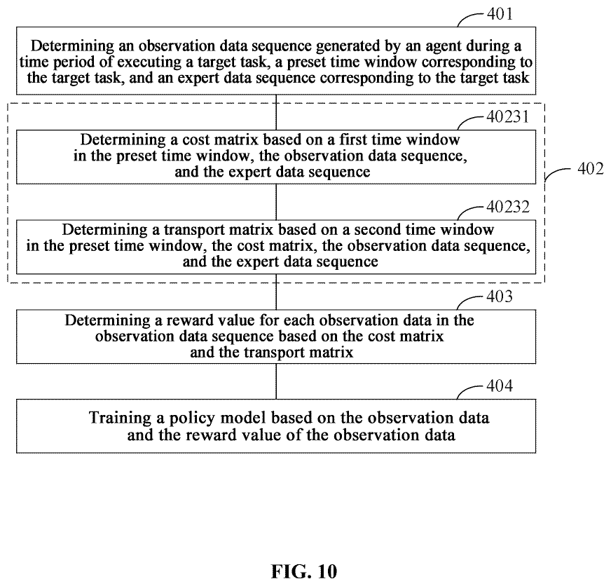

In still another implementation, as shown in FIG. 10, on the basis of the embodiment shown in FIG. 4, step 402 may include the following steps 40231 and 40232.

Step 40231: determining the cost matrix based on a first time window in the preset time window, the observation data sequence, and the expert data sequence.

For example, the preset time window may include a first time window k_{c} and a second time window kₘ. A plurality of observation data in the first time window may be used as the context data of the observation data. The value of each element

$$\hat{c} ( {o}_{i} , {o}_{j}^{E} )$$

in the cost matrix Ĉ may be determined in combination with the context data of each observation data by using a calculation formula as shown in formula (2). The second cost value

$$\hat{c} ( {o}_{i} , {o}_{j}^{E} )$$

for each observation data oᵢ and each expert data

$${o}_{j}^{E}$$

is calculated according to formula (2). The second cost value

$$\hat{c} ( {o}_{i} , {o}_{j}^{E} )$$

for each observation data oᵢ and each expert data

$${o}_{j}^{E}$$

is used as the value of each element in the cost matrix Ĉ, so as to obtain the cost matrix Ĉ.

In the embodiments of the present disclosure, the cost matrix may be determined in combination with the first time window, so that the value of each element in the cost matrix is determined by considering first cost values for a plurality of observation data and a plurality of expert data within the time window, thereby ensuring that the accuracy of determined cost matrix considering the timing information is higher.

Step 40232: determining the transport matrix based on a second time window in the preset time window, the cost matrix, the observation data sequence, and the expert data sequence.

When the basic transport matrix μ is optimized to obtain the optimal transport matrix, the transport matrix μ* related to the timing information may be determined by embedding the timing information. When considering the timing information, time masking may be performed on the basic transport matrix μ based on the second time window kₘ to obtain a time mask transport matrix, which is denoted as M⊙μ. Subsequently, the time mask transport matrix M⊙μ is optimized based on the cost matrix Ĉ considering the first time window, the observation data sequence {o₀, o₁, . . . , oᵢ, . . . , o_{T-1}}, and the expert data sequence

$$\{ {o}_{0}^{E} , {o}_{1}^{E} , … , {o}_{j}^{E} , … , {o}_{T - 1}^{E} \} ,$$

so as to obtain the transport matrix μ* related to the timing information. Specifically, the transport matrix μ* related to the timing information may be represented in a vector form according to the following formula (8):

$${μ}^{*} = {argmin}_{μ} {〈 M ⊙ μ , \hat{C} 〉}_{F} - ϵℋ ( M ⊙ μ ) s . t . μ1 = {μ}^{T} 1 = s . \qquad ( 8 )$$

In formula (8), [symbol] ·,· [symbol] represents a F− norm. M⊙μ represents term-by-term multiplication of M and μ, where M represents the time mask matrix, and M(i,j)∈[0,1]. [symbol] (·) represents an entropy regularization term of the time mask transport matrix M⊙μ. A sum of rows and a sum of columns of the basic transport matrix μ meet a constraint condition

$$s = [ \frac{1}{T} , … , \frac{1}{T} ] .$$

For example, formula (8) may be transformed into an unconstrained optimization problem through the Lagrangian reformulation. An objective function of the unconstrained optimization problem is shown in the following formula (9):

$$L ( μ , α , β ) = {〈 M ⊙ μ , \hat{C} 〉}_{F} + ϵ ( {〈 M ⊙ μ , log ( M ⊙ μ ) 〉}_{F} - {1}^{T} ( M ⊙ μ ) 1 ) - {〈 α , ( M ⊙ μ ) 1 - s 〉}_{F} - {〈 β , {( M ⊙ ρ )}^{T} 1 - s 〉}_{F} . \qquad ( 9 )$$

In formula (9), α and β represent two Lagrangian multipliers. For an example calculation formula of the time mask matrix M, reference may be made to formula (7).

In the embodiments of the present disclosure, time masking is performed through the second time window, so that the use scope of the optimal transport reward can be limited, thereby improving the quality of the transport matrix.

In the embodiments of the present disclosure, when determining the cost matrix and the transport matrix in combination with the first time window and the second time window, the timing performance of the observation data in the observation data sequence and the timing performance of the expert data in the expert data sequence are considered, so that the cost matrix and the transport matrix that are related to the timing information can be determined, thereby ensuring that the accuracy of the reward value determined based on the cost matrix and the transport matrix is higher.

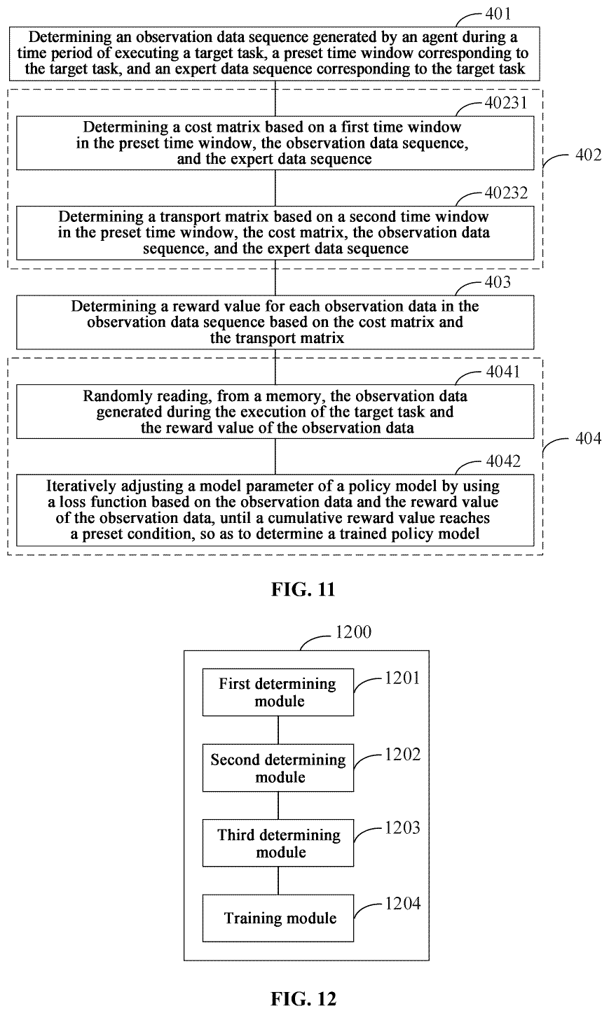

As shown in FIG. 11, on the basis the foregoing embodiments, step 404 may include the following steps 4041 and 4042.

Step 4041: randomly reading, from a memory, the observation data generated during the execution of the target task and the reward value of the observation data.

For example, in a process of determining the reward value of each observation data, the electronic device collects actions executed by the agent in the process of executing the target task. The current observation data, the execution action, the reward value, and a next observation data are taken as a data information group. The electronic device collects a series of data information groups generated during the execution of the target task, and stores the same into the memory.

Each time performing iterative training on the policy model, the electronic device may randomly read the data information group of the target task from the memory for training. The reward value corresponding to the observation data in the data information group is the reward value calculated according to steps 401 to 403. This reward value is a reward value with higher accuracy that is calculated under a constraint of considering the timing information.

Step 4042: iteratively adjusting a model parameter of the policy model by using a loss function based on the observation data and the reward value of the observation data, until a cumulative reward value reaches a preset condition, so as to determine a trained policy model.

For example, the electronic device may randomly read a batch of data information groups from the memory at each iteration, and an i^{th} data information group may be denoted as (Sᵢ, Aᵢ, Rᵢ, Sᵢ₊₁), where i=1, 2, . . . , or N, and N represents the number of data information groups that are read. The electronic device iteratively adjusts the model parameter of the policy model by using the loss function based on the current observation data, the execution action, the reward value, and the next observation data, until the cumulative reward value reaches the preset condition, so as to obtain the trained policy model. This policy model may be referred to as an optimal policy model.

In some embodiments, that the cumulative reward value reaches the preset condition includes: the cumulative reward value is greater than a preset threshold, or the cumulative reward value is maximum. Content of the preset condition is not limited in the embodiments of the present disclosure.

In the embodiments of the present disclosure, reinforcement learning is performed by using pre-stored observation data and the reward value thereof. The reward value of the observation data is a reward value with higher accuracy that is generated by constraining the optimal transport when considering the timing information. The reinforcement learning is performed based on the reward value with higher accuracy, so that it can be ensured that a better policy model is learned.

### Exemplary Apparatus

FIG. 12 is a schematic diagram of a composition structure of an apparatus for training a policy model based on reinforcement learning according to an exemplary embodiment of the present disclosure. As shown in FIG. 12, an apparatus for training a policy model based on reinforcement learning 1200 includes a first determining module 1201, a second determining module 1202, a third determining module 1203, and a training module 1204.

The first determining module 1201 is configured to determine an observation data sequence generated by an agent during a time period of executing a target task, a preset time window corresponding to the target task, and an expert data sequence corresponding to the target task.

The second determining module 1202 is configured to determine a cost matrix and a transport matrix based on the preset time window, the observation data sequence, and the expert data sequence.

The third determining module 1203 is configured to determine a reward value for each observation data in the observation data sequence based on the cost matrix and the transport matrix.

The training module 1204 is configured to train the policy model based on the observation data and the reward value of the observation data.

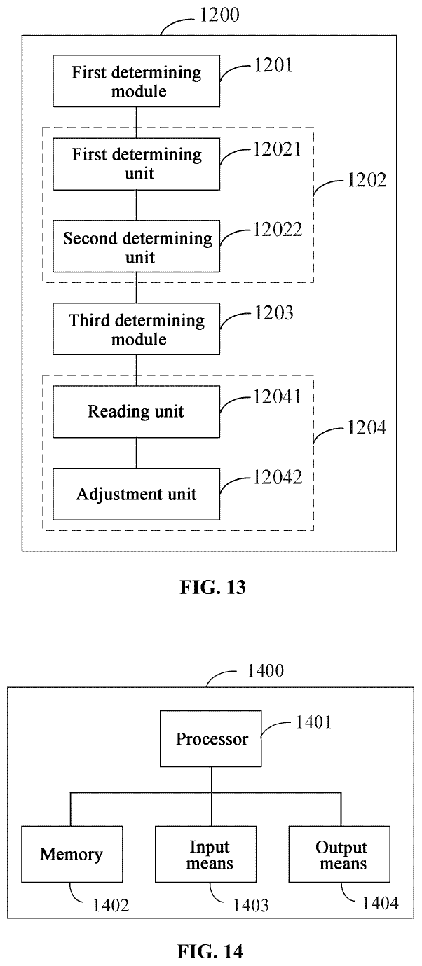

In some embodiments, as shown in FIG. 13, the second determining module 1202 may include a first determining unit 12021 and a second determining unit 12022.

The first determining unit 12021 is configured to determine the cost matrix based on a first time window in the preset time window, the observation data sequence, and the expert data sequence.

The second determining unit 12022 is configured to determine the transport matrix based on the cost matrix, the observation data sequence, and the expert data sequence.

In some embodiments, the first determining unit 12021 may also be configured to determine the cost matrix based on the observation data sequence and the expert data sequence.

In some embodiments, the second determining unit 12022 may also be configured to determine the transport matrix based on a second time window in the preset time window, the cost matrix, the observation data sequence, and the expert data sequence.

In some embodiments, the first determining unit 12021 may also be configured to: determine, based on the first time window, a plurality of observation data groups corresponding to the first time window from the observation data sequence, and determine a plurality of expert data groups corresponding to the first time window from the expert data sequence; and determine the cost matrix based on each of the observation data groups and each of the expert data groups.

In some embodiments, the first determining unit 12021 may also be configured to: determine a first cost value for each observation data in each of the observation data groups and corresponding expert data in each of the expert data groups based on a plurality of observation data in each of the observation data groups and a plurality of expert data in each of the expert data groups; determine a second cost value for each observation data and each expert data based on the first cost value for each observation data in each of the observation data groups and the corresponding expert data in each of the expert data groups; and determine the cost matrix based on the second cost value for each observation data and each expert data.

In some embodiments, the second determining unit 12022 may also be configured to: determine a time mask matrix based on the second time window, the number of observation data in the observation data sequence, and the number of expert data in the expert data sequence; and determine the transport matrix based on the time mask matrix and the cost matrix.

In some embodiments, the second determining unit 12022 may also be configured to: determine a size of the time mask matrix based on the number of the observation data in the observation data sequence and the number of the expert data in the expert data sequence; and determine a numeric value of each element in the time mask matrix based on the size of the time mask matrix and the second time window.

In some embodiments, as shown in FIG. 13, the training module 1204 may include a reading unit 12041 and an adjustment unit 12042.

The reading unit 12041 is configured to randomly read, from a memory, the observation data generated during the execution of the target task and the reward value of the observation data.

The adjustment unit 12042 is used to iteratively adjust a model parameter of the policy model by using a loss function based on the observation data and the reward value of the observation data, until a cumulative reward value reaches a preset condition, so as to determine a trained policy model.

For beneficial technical effects corresponding to the exemplary embodiments of the foregoing apparatus for training a policy model based on reinforcement learning, reference may be made to the corresponding beneficial technical effects in the part of exemplary method described above, and details are not described herein again.

### Exemplary Electronic Device

FIG. 14 is a schematic diagram of a composition structure of an electronic device according to an exemplary embodiment of the present disclosure. As shown in FIG. 14, an electronic device 1400 includes at least one processor 1401 and a memory 1402.

The processor 1401 may be a central processing unit (CPU) or another form of processing unit having a data processing capability and/or an instruction execution capability, and may control another component in the electronic device 1400 to implement a desired function.

The memory 1402 may include one or more computer program products. The computer program product may include various forms of computer readable storage media, such as a volatile memory and/or a non-volatile memory. The volatile memory may include, for example, a random access memory (RAM) and/or a cache. The nonvolatile memory may include, for example, a read-only memory (ROM), a hard disk, and a flash memory. One or more computer program instructions may be stored on the computer readable storage medium. The processor 1401 may execute the one or more program instructions to implement the method for a reinforcement learning model according to various embodiments of the present disclosure that are described above and/or other desired functions. The method may include determining an observation data sequence generated by an agent during a time period of executing a target task, a preset time window corresponding to the target task, and an expert data sequence corresponding to the target task; determining a cost matrix and a transport matrix based on the preset time window, the observation data sequence, and the expert data sequence; determining a reward value for each observation data in the observation data sequence based on the cost matrix and the transport matrix; and training the policy model based on the observation data and the reward value of the observation data.

In an example, the electronic device 1400 may further include an input means 1403 and an output means 1404. These components are connected to each other through a bus system and/or another form of connection mechanism (not shown).

The input means 1403 may further include, for example, a keyboard and a mouse.

The output means 1404 may output various information to the outside, and may include, for example, a display, a speaker, a printer, a communication network, and a remote output device connected by the communication network.

To describing clearly the technical concept of the present disclosure, FIG. 14 shows only some of components in the electronic device 1400 that are related to the present disclosure, and components such as a bus and an input/output interface are omitted. In addition, according to specific application situations, the electronic device 1400 may further include any other appropriate components.

### Exemplary Computer Program Product and Computer Readable Storage Medium

In addition to the foregoing method and device, the embodiments of the present disclosure may also provide a computer program product, which includes computer program instructions. When the computer program instructions are run by a processor, the processor is enabled to perform the steps, of the method for a reinforcement learning model according to the embodiments of the present disclosure, that are described in the “exemplary method” part described above.

The computer program product may be program code, written with one or any combination of a plurality of programming languages, that is configured to perform the operations in the embodiments of the present disclosure. The programming languages include an object-oriented programming language such as Java or C++, and further include a conventional procedural programming language such as a “C” language or a similar programming language. The program code may be entirely or partially executed on a user computing device, executed as an independent software package, partially executed on the user computing device and partially executed on a remote computing device, or entirely executed on the remote computing device or a server.

In addition, the embodiments of the present disclosure may further relate to a computer readable storage medium, on which a computer program is stored. When the computer program instructions are run by the processor, the processor is enabled to perform the steps, of the method for a reinforcement learning model according to the embodiments of the present disclosure, that are described in the “exemplary method” part described above.

The computer readable storage medium may be one readable medium or any combination of a plurality of readable media. The readable medium may be a readable signal medium or a readable storage medium. The readable storage medium includes, for example but is not limited to electricity, magnetism, light, electromagnetism, infrared ray, or a semiconductor system, an apparatus, or a device, or any combination of the above. More specific examples (a non-exhaustive list) of the readable storage medium include: an electrical connection with one or more conducting wires, a portable disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above.

Basic principles of the present disclosure are described above in combination with specific embodiments. However, advantages, superiorities, and effects mentioned in the present disclosure are merely examples but are not for limitation, and it cannot be considered that these advantages, superiorities, and effects are necessary for each embodiment of the present disclosure. In addition, specific details described above are merely for examples and for ease of understanding, rather than limitations. The details described above do not limit that the present disclosure must be implemented by using the foregoing specific details.

A person skilled in the art may make various modifications and variations to the present disclosure without departing from the spirit and the scope of the present disclosure. In this way, if these modifications and variations of this application fall within the scope of the claims and equivalent technologies of the claims of the present disclosure, the present disclosure also intends to include these modifications and variations.

What is claimed is:

1. A method for training a policy model based on reinforcement learning, comprising:
determining an observation data sequence generated by an agent during a time period of executing a target task, a preset time window corresponding to the target task, and an expert data sequence corresponding to the target task;
determining a cost matrix and a transport matrix based on the preset time window, the observation data sequence, and the expert data sequence;
determining a reward value for each observation data in the observation data sequence based on the cost matrix and the transport matrix; and
training the policy model based on the observation data and the reward value of the observation data.

2. The method according to claim 1, wherein the determining a cost matrix and a transport matrix based on the preset time window, the observation data sequence, and the expert data sequence comprises:
determining the cost matrix based on a first time window in the preset time window, the observation data sequence, and the expert data sequence; and
determining the transport matrix based on the cost matrix, the observation data sequence, and the expert data sequence.

3. The method according to claim 2, wherein the determining the transport matrix based on the cost matrix, the observation data sequence, and the expert data sequence comprises:
determining the transport matrix based on a second time window in the preset time window, the cost matrix, the observation data sequence, and the expert data sequence.

4. The method according to claim 2, wherein the determining the cost matrix based on a first time window in the preset time window, the observation data sequence, and the expert data sequence comprises:
determining, based on the first time window, a plurality of observation data groups corresponding to the first time window from the observation data sequence, and a plurality of expert data groups corresponding to the first time window from the expert data sequence; and
determining the cost matrix based on each of the observation data groups and each of the expert data groups.

5. The method according to claim 4, wherein the determining the cost matrix based on each of the observation data groups and each of the expert data groups comprises:
determining a first cost value for each observation data in each of the observation data groups and corresponding expert data in each of the expert data groups based on a plurality of observation data in each of the observation data groups and a plurality expert data in each of the expert data groups;
determining a second cost value for each observation data and each expert data based on the first cost value for each observation data in each of the observation data groups and the corresponding expert data in each of the expert data groups; and
determining the cost matrix based on the second cost value for each observation data and each expert data.

6. The method according to claim 3, wherein the determining the transport matrix based on a second time window in the preset time window, the cost matrix, the observation data sequence, and the expert data sequence comprises:
determining a time mask matrix based on the second time window, a number of observation data in the observation data sequence, and a number of expert data in the expert data sequence; and
determining the transport matrix based on the time mask matrix and the cost matrix.

7. The method according to claim 6, wherein the determining a time mask matrix based on the second time window, a number of observation data in the observation data sequence, and a number of expert data in the expert data sequence comprises:
determining a size of the time mask matrix based on the number of the observation data in the observation data sequence and the number of the expert data in the expert data sequence; and
determining a numeric value of each element in the time mask matrix based on the size of the time mask matrix and the second time window.

8. The method according to claim 1, wherein the training the policy model based on the observation data and the reward value of the observation comprises:
randomly reading, from a memory, the observation data generated during the execution of the target task and the reward value of the observation data; and
iteratively adjusting a model parameter of the policy model by using a loss function based on the observation data and the reward value of the observation data, until a cumulative reward value reaches a preset condition, so as to determine a trained policy model.

9. A non-transitory computer readable storage medium, on which a computer program is stored, wherein the computer program is configured to implement the following steps of:
determining an observation data sequence generated by an agent during a time period of executing a target task, a preset time window corresponding to the target task, and an expert data sequence corresponding to the target task;
determining a cost matrix and a transport matrix based on the preset time window, the observation data sequence, and the expert data sequence;
determining a reward value for each observation data in the observation data sequence based on the cost matrix and the transport matrix; and
training the policy model based on the observation data and the reward value of the observation data.

10. The non-transitory computer readable storage medium according to claim 9, wherein the determining a cost matrix and a transport matrix based on the preset time window, the observation data sequence, and the expert data sequence comprises:
determining the cost matrix based on a first time window in the preset time window, the observation data sequence, and the expert data sequence; and
determining the transport matrix based on the cost matrix, the observation data sequence, and the expert data sequence.

11. The non-transitory computer readable storage medium according to claim 10, wherein the determining the transport matrix based on the cost matrix, the observation data sequence, and the expert data sequence comprises:
determining the transport matrix based on a second time window in the preset time window, the cost matrix, the observation data sequence, and the expert data sequence.

12. The non-transitory computer readable storage medium according to claim 10, wherein the determining the cost matrix based on a first time window in the preset time window, the observation data sequence, and the expert data sequence comprises:
determining, based on the first time window, a plurality of observation data groups corresponding to the first time window from the observation data sequence, and a plurality of expert data groups corresponding to the first time window from the expert data sequence; and
determining the cost matrix based on each of the observation data groups and each of the expert data groups.

13. An electronic device, comprising:
a processor; and
a memory configured to store processor-executable instructions,
wherein the processor is configured to read the executable instructions from the memory, and execute the instructions to implement the following steps of:
determining an observation data sequence generated by an agent during a time period of executing a target task, a preset time window corresponding to the target task, and an expert data sequence corresponding to the target task;
determining a cost matrix and a transport matrix based on the preset time window, the observation data sequence, and the expert data sequence;
determining a reward value for each observation data in the observation data sequence based on the cost matrix and the transport matrix; and
training the policy model based on the observation data and the reward value of the observation data.

14. The method according to claim 13, wherein the determining a cost matrix and a transport matrix based on the preset time window, the observation data sequence, and the expert data sequence comprises:
determining the cost matrix based on a first time window in the preset time window, the observation data sequence, and the expert data sequence; and
determining the transport matrix based on the cost matrix, the observation data sequence, and the expert data sequence.

15. The method according to claim 14, wherein the determining the transport matrix based on the cost matrix, the observation data sequence, and the expert data sequence comprises:
determining the transport matrix based on a second time window in the preset time window, the cost matrix, the observation data sequence, and the expert data sequence.

16. The method according to claim 14, wherein the determining the cost matrix based on a first time window in the preset time window, the observation data sequence, and the expert data sequence comprises:
determining, based on the first time window, a plurality of observation data groups corresponding to the first time window from the observation data sequence, and a plurality of expert data groups corresponding to the first time window from the expert data sequence; and
determining the cost matrix based on each of the observation data groups and each of the expert data groups.

17. The method according to claim 16, wherein the determining the cost matrix based on each of the observation data groups and each of the expert data groups comprises:
determining a first cost value for each observation data in each of the observation data groups and corresponding expert data in each of the expert data groups based on a plurality of observation data in each of the observation data groups and a plurality expert data in each of the expert data groups;
determining a second cost value for each observation data and each expert data based on the first cost value for each observation data in each of the observation data groups and the corresponding expert data in each of the expert data groups; and
determining the cost matrix based on the second cost value for each observation data and each expert data.

18. The method according to claim 15, wherein the determining the transport matrix based on a second time window in the preset time window, the cost matrix, the observation data sequence, and the expert data sequence comprises:
determining a time mask matrix based on the second time window, a number of observation data in the observation data sequence, and a number of expert data in the expert data sequence; and
determining the transport matrix based on the time mask matrix and the cost matrix.

19. The method according to claim 18, wherein the determining a time mask matrix based on the second time window, a number of observation data in the observation data sequence, and a number of expert data in the expert data sequence comprises:
determining a size of the time mask matrix based on the number of the observation data in the observation data sequence and the number of the expert data in the expert data sequence; and
determining a numeric value of each element in the time mask matrix based on the size of the time mask matrix and the second time window.

20. The method according to claim 13, wherein the training the policy model based on the observation data and the reward value of the observation comprises:
randomly reading, from a memory, the observation data generated during the execution of the target task and the reward value of the observation data; and
iteratively adjusting a model parameter of the policy model by using a loss function based on the observation data and the reward value of the observation data, until a cumulative reward value reaches a preset condition, so as to determine a trained policy model.
